(19) United States
(12) Patent Application Publication
(10) Pub. No.: US 2009/0066604 A1
(43) Pub. Date: Mar. 12, 2009

(54) Attachment Apparatus With Antenna

(76) Inventor: Eagle Fan, Hsinchu (TW)

Correspondence Address: LIN & ASSOCIATES INTELLECTUAL PROPERTY, INC., P.O. BOX 2339, SARATOGA, CA, 95070-0339, US

(21) Appl. No.: 11/850,680

(22) Filed: Sep. 6, 2007

(51) Int. Cl. H01Q 1/12; H01Q 1/08

(52) U.S. Cl. 343/880

(57) ABSTRACT

An attachment apparatus with antenna is provided, including a connection unit, a support unit and an antenna unit. The connection unit includes at least a first attachment part. The first attachment part can be attached to the device holder for vehicle. The support unit partially extends into and is fastened to the inside of the connection unit. The support unit is bendable. The antenna unit is connected to the other end of the support unit. The antenna unit includes a connection wire for connecting the electronic device. The attachment apparatus with antenna is applicable to a wide range of device holders for vehicle.

### FIELD OF THE INVENTION

The present invention generally relates to a device holder apparatus for vehicle, and more specifically to an attachment apparatus with antenna, applicable to various device holders for vehicles.

### BACKGROUND OF THE INVENTION

A wide range of portable electronic devices are becoming a part of the modern daily life for most people, such as mobile phones, audiovisual player, PDA, GPS, digital TV, and so on. These electronic devices are also used in vehicles. However, as most of the electronic devices are not standard options to the majority of the vehicles, the driver usually needs an additional holder to hold the electronic devices in place so that the use of these electronic devices will not interfere with the driving. One popular design of the holder uses a supportive rod and a clipping holding part. Based on the attachment method, the bottom of the supportive rod can further divided into two categories, suction disc and glue. The supportive rod uses the internal joint structure for position adjustment. The clipping holding part is for clipping and holding the electronic device. The engagement between the supportive rod and the clipping holding part uses a detachable buckle mechanism that can be easily disengaged and re-engaged. So that when different electronic devices are used, only different clipping holding parts are removed and replaced, instead of changing the entire device holder.

Many of the electronic devices used in the vehicle come with an antenna set for providing better reception for wireless communication devices, such as GPS, DTV, and so on. However, the design of the convention holder with sucker usually does not provide additional holder to the antenna set of these wireless communication devices. Therefore, some antenna set is attached to the ceiling by a magnet. Alternatively, additional conductive wire is used to connect the antenna set placed on the dash board close to the windshield. With the limited space in the vehicle, the additional wires for antenna set is not only in convenient, but also dangerous to interfere with the driving. In addition, when different electronic devices are held by the holder, different antenna sets must be used. The removal and replacement of the antenna set is an additional inconvenience.

Therefore, it is important to devise an attachment apparatus with an antenna that is applicable to various device holders for vehicles so that the user can easily install the attachment apparatus to the device holder to hold the devices that uses antenna.

### SUMMARY OF THE INVENTION

The primary object of the present invention is to provide a replaceable attachment apparatus with antenna, for using with the device holders for vehicle. When the driver uses the holder to hold the wireless communication device, the present invention can be used to accommodate the wireless communication device, and the antenna of the present invention can be used for signal reception to eliminate the scattered additional wires. As the attachment apparatus with antenna of the present invention is not of any specific standard, it is applicable to a wide range of device holders.

Another object of the present invention is to provide an attachment apparatus that is visually esthetic and inexpensive to replace. The attachment apparatus is to be attached to the device holder so that when a wireless communication device is held in the holder, the wireless communication device is also connected to the attachment apparatus without conventional problem of scattered wires. In addition, the antenna of the present invention is also behind the device holder so that the antenna will not interfere the driving. As the attachment apparatus can be used with existing device holder, it is not necessary to replace the existing device holder.

To achieve the above objects, the present invention provides an attachment apparatus with antenna, including a connection unit, a support unit and an antenna unit. The connection unit includes at least a first attachment part. The first attachment part can be attached to the device holder for vehicle. The support unit partially extends to the inside of the connection unit and is fastened there. The support unit is bendable. The antenna unit is connected to the other end of the support unit. The antenna unit includes a connection wire for connecting the electronic device. The attachment apparatus with antenna is applicable to a wide range of device holders for vehicle.

When the support unit of the present invention is retractable, the connection unit further includes an accommodating trench and a locking buckle unit. The accommodating trench is formed inside the connection unit, and the support unit is partially placed inside the accommodating trench. The locking buckle unit is located in the connection unit so that the locking buckle can lock the support unit in place inside the accommodating trench.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a three-dimensional schematic view of the present invention;

FIG. 2 shows another schematic view of the present invention from a different angle;

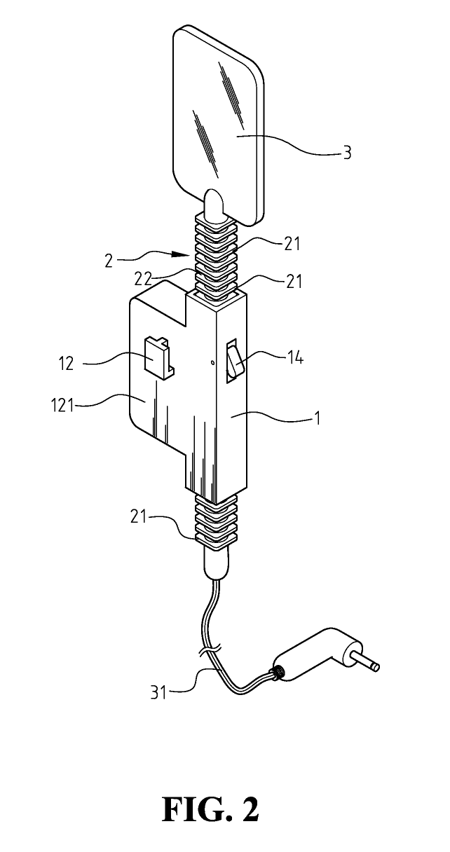

FIG. 3 shows a partial cross-sectional view of the present invention;

FIG. 4 shows a schematic view of antenna adjustment of the present invention;

FIG. 5 shows a schematic view of the present invention in actual application; and

FIG. 6 shows a schematic view of a second embodiment of the present invention.

### DETAILED DESCRIPTION OF THE PREFERRED EMBODIMENTS

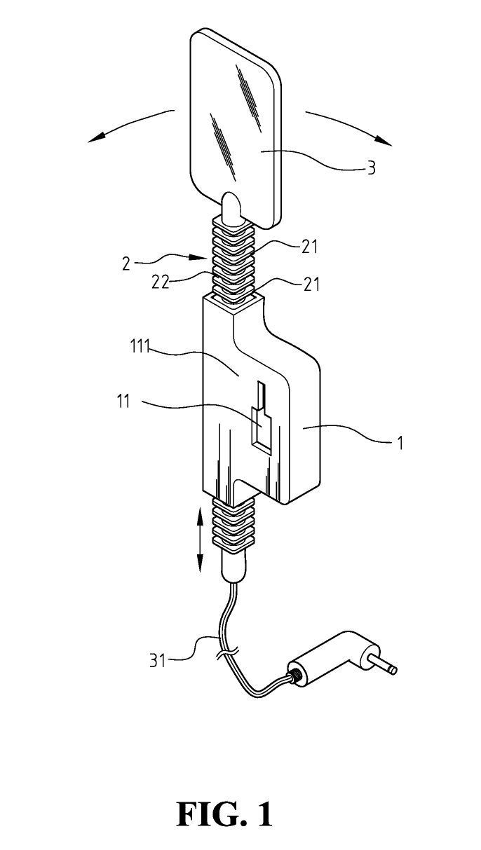

FIG. 1 shows a schematic view of the present invention. An attachment apparatus with antenna of the present invention includes a connection unit 1, a support unit 2 and an antenna unit 3. Connection unit 1 further includes at least a first attachment part 11 for attaching to another object, such as device holder. Support unit 2 is a bendable element, and is partially extends into and fastened inside connection unit 1. Antenna unit 3 is connected to the other end of support unit 2. Antenna unit 3 includes a connection wire 31 for connecting a wireless communication device. The present invention uses connection unit 1 to attach to the device holder, and the device holder can be placed and fixed to an appropriate location in a vehicle. Support unit 2 uses the flexibility to adjust the position of antenna unit 3 so that antenna unit 3 can have a better reception of signals.

Although support unit 2 is connected and fastened to connection unit 1, support unit 2 can be divided into two types, retractable and non-retractable. The non-retractable support unit 2 is a support unit that can only adjust the antenna position by bending. A retractable support unit 2 is a support unit that can retract or extend for a small distance to change the position of the antenna. The embodiment of the present invention shows the retractable support unit, but the present invention is not limited to this embodiment.

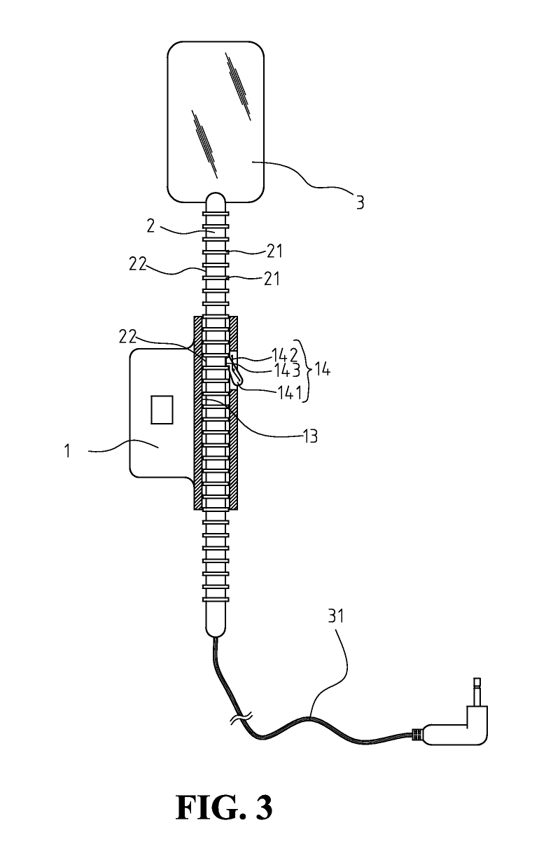

As shown in FIGS. 1&2, connection unit 1 includes a first attachment part 11, a second attachment part 12, an accommodating trench 13, and a locking buckle 14. The shape of connection unit 1 is rectangle, with a large first area 111 and a large second area 121 facing each other. First attachment part 11 and second attachment part 12 are on first area 111 and second area 121 respectively. The shapes of first attachment part 11 and second attachment part 12 are designed to match the object to be attached to. In this embodiment, first attachment part 11 is a concave locking trench, and second attachment part 12 is a protruding T-shape locking block. As shown in FIG. 3, The interior of connection unit 1 further includes a long accommodating trench 13. Accommodating trench 13 penetrates through connection unit 1 entirely, and is for accommodating support unit 2 when retracted. The cross-section of accommodating trench is not circular, but a square, so as to prevent support unit 2 from rotating. Support unit 2 can move along the axis of accommodating trench 13 to change the length of support unit 2 extending outside of connection unit 1. A locking buckle unit 14 is included inside connection unit 1 at the location near to the middle point of accommodating trench 13 for locking support unit 2 in place. Locking buckle unit 14 further includes a button 141 and a resilient element 142. One end of button 141 is a block 143 with the middle coupled to the inner wall of connection unit 1. Resilient element 142 is a button spring and is engaged to the coupling location of button 141 to provide button 141 the automatic recovery resilience after pressed. Block 143 has a shape matching the shape of support unit 2 to prevent support unit 2 from accidental retraction or extension.

Support unit 2 is bendable long column, and can be made of material such as metal coated with a plastic layer. Support unit 2 includes a plurality of non-circular ribs 21 arranged in a ring on the outside. In the present embodiment, ribs 21 are square-shaped to match the shape of accommodating trench 13. A small concave ring trench 22 is between two neighboring ribs 21 for block 143 of locking buckle unit 14 to block and lock.

Antenna unit 3 is connected to the other end of support unit 2. Antenna unit 3 includes a hidden antenna loop or circuit, designed to match the wireless communication device. Antenna unit 3 further includes a connection wire 31 for connecting the wireless communication device. In the present embodiment, the front end of connection wire 31 is inside antenna unit 3, the middle segment is buried inside support unit 2, and the rear end extends from the bottom of support unit 2 for connecting to wireless communication device.

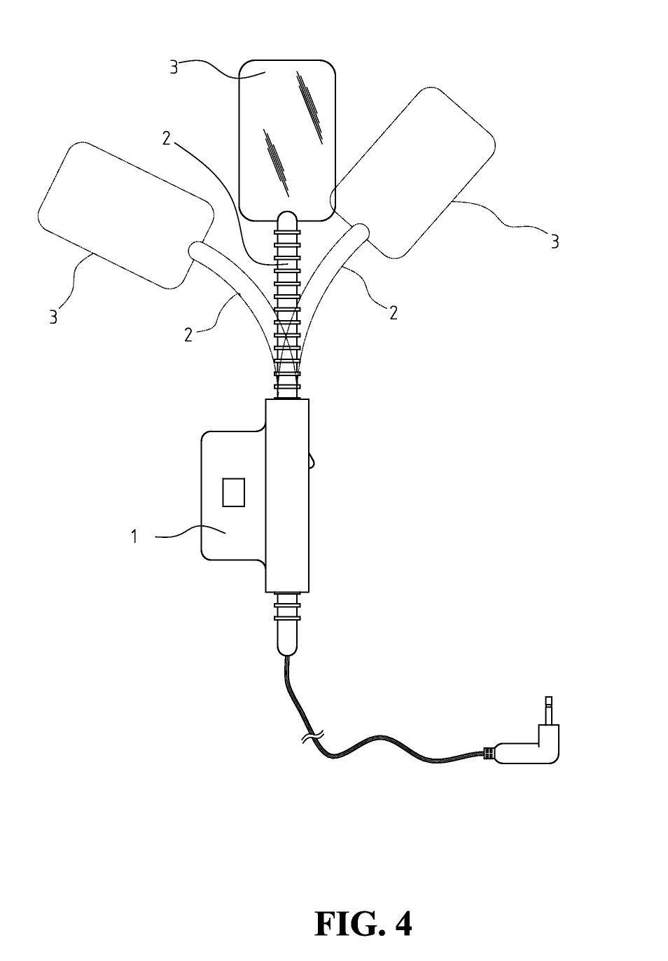

As shown in FIG. 4, to adjust the position of antenna unit 3, the user must first pull support unit 2 to the desired length, and then bend the support unit 2 to desired angle so that antenna unit 3 is adjusted to the best position for reception of signals. When used with device holder for vehicle, the antenna of the present invention can be adjusted by adjusting support unit 2.

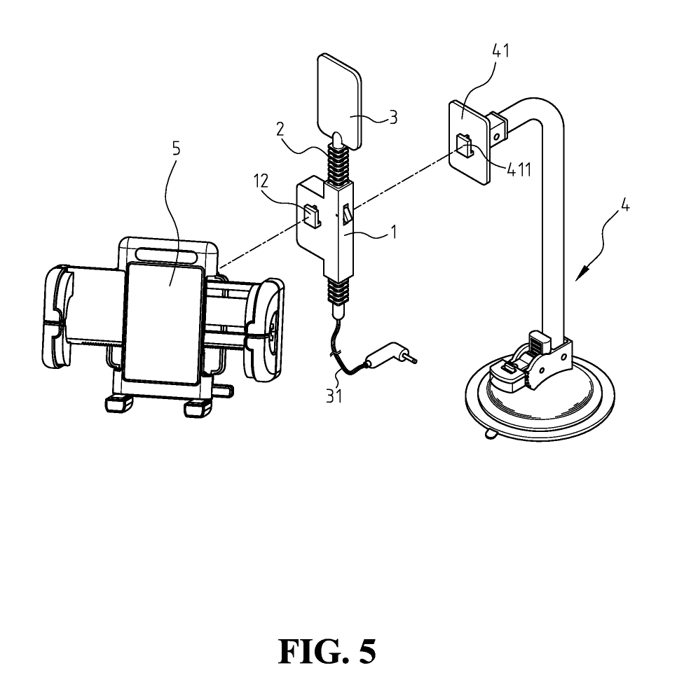

FIG. 5 shows a schematic view of the present invention in actual application. As shown in FIG. 5, the present invention is used with a device holder 4 with a suction disc. The top of suction holder 4 is an attachment plate 41 to connect a clipping holding part 5. When in use of the present invention, the user must first remove clipping holding part 5. Because connection unit 1 of the present invention includes a first attachment part 11 and second attachment part 12, the shape of first attachment part 11 of the present embodiment matches the shape of the back of clipping holding part 5, and the shape of second attachment 12 of the present embodiment matches the shape of block 411 of attachment plate 41, connection unit 1 uses first attachment part 11 to engage attachment plate 41 of suction holder 4, and uses second attachment part 12 to engage clipping holding part 5. Therefore, when a wireless communication device, such as GPS, is held by clipping holding part 5, connection wire 31 of antenna unit 3 of the present invention can be connected to GPS. Finally, suction holder 4 can be attached to windshield, and support unit 2 is adjusted to allow the best reception of signal for antenna unit 3.

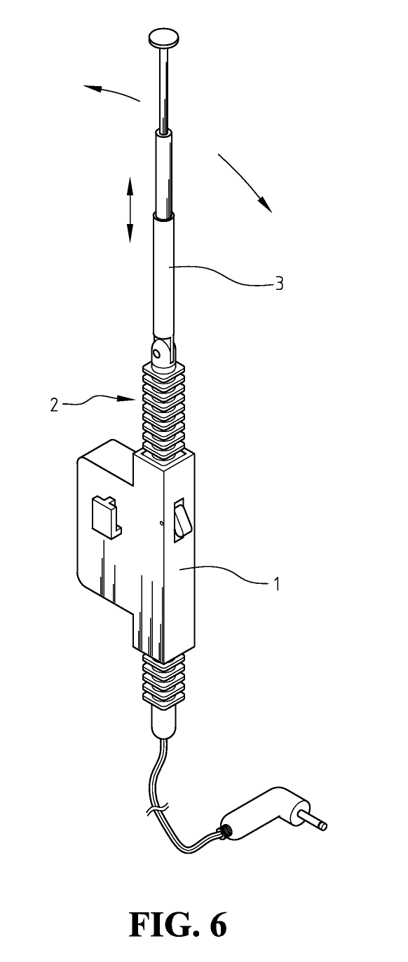

FIG. 6 shows a second embodiment of the present invention. In the second embodiment, the structure of antenna unit 3 is different. As shown in FIG. 6, antenna unit 3 is connected to one end of support unit 2. Retractable antenna 32 is pulled out and rotated for adjustment. Therefore, antenna unit 3 of the present invention is not limited to specific planar antenna.

In summary, the attachment apparatus with antenna of the present invention uses the shape of connection unit to match conventional device holder for vehicle to widen the application of the present invention. The adjustability of the support unit and antenna unit allows the user to find the best reception of the signals without the disadvantages of the conventional device holder.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An attachment apparatus with antenna, comprising:
a connection unit, further comprising at least a first attachment part for attaching to another object;
a support unit, being a bendable element, partially extending into and fastened inside said connection unit; and
an antenna unit, connected to the top of said support unit, further comprising a connection wire for connecting an electronic device.

2. The apparatus as claimed in claim 1, wherein said connection unit has a large first area and a large second area facing each other, said first area has a first attachment part and said second area has a second attachment part, and the shapes of said first attachment part and said second attachment part are designed to match the object to be attached to.

3. The apparatus as claimed in claim 1, wherein the interior of said connection unit further comprises an accommodating trench and a locking buckle unit, said accommodating trench penetrating entirely through said connection unit and providing space for accommodating said support unit, and said locking buckle unit is located at the position on said accommodating trench that can lock said support unit in place inside said accommodating trench.

4. The apparatus as claimed in claim 3, wherein said accommodating trench has the shape matching the shape of said support unit.

5. The apparatus as claimed in claim 3, wherein said support unit further comprises a plurality of ribs arranged in a ring on the outside, the shape of said ribs matches the shape of said accommodating trench, and a smaller concave ring trench is located between two said neighboring ribs.

6. The apparatus as claimed in claim 3, wherein said locking buckle unit further comprises a button and a resilient element, one end of said button is a block with middle position coupled to the inner wall of said connection unit, said resilient element is a button spring engaged to the coupling position of said button, and said block has the shape matching the shape of said support unit.

7. The apparatus as claimed in claim 1, wherein said antenna unit is a retractable antenna

8. The apparatus as claimed in claim 1, wherein said antenna unit comprises a hidden antenna loop.
